(19) United States
(12) Patent Application Publication
(10) Pub. No.: US 2017/0339702 A1
(43) Pub. Date: Nov. 23, 2017

(54) COMMUNICATION SYSTEM AND A METHOD FOR TRANSMITTING DATA OVER A COMMUNICATION NETWORK

(71) Applicant: Macau University of Science and Technology, Taipa (MO)

(72) Inventors: Qinglin Zhao, Taipa (MO); Yuan Wu, Taipa (MO); Haohan Chai, Taipa (MO); Liping Qian, Taipa (MO); Weidang Lu, Taipa (MO); ChangSheng Yu, Taipa (MO)

(21) Appl. No.: 15/160,014

(22) Filed: May 20, 2016

(51) Int. Cl. H04W 72/08; H04W 28/10; H04W 28/02

(52) U.S. Cl. CPC H04W 72/082; H04W 28/0236; H04W 28/10

(57) ABSTRACT

A communication system and a method for transmitting data over a communication network includes a processing module arranged for selectively splitting a traffic demand of a transmission link into a plurality of portions of traffic demands distributed over a main channel and at least one auxiliary channel of the communication network, and the processing module is further arranged to determine a data transmission relationship associated with the traffic demand of the transmission link and at least one parameter of both the main channel and the at least one auxiliary channel; and a transmission module arranged to transmit data over one or more of the main channel and the at least one auxiliary channel according to the data transmission relationship.

### TECHNICAL FIELD

The present invention relates to a communication system and a method for transmitting data over a communication network, although not exclusively, to a system and method for distributing a traffic demand of a transmission link over a licensed and an unlicensed spectrum in a communication network.

### BACKGROUND

Data may be transmitted in form of electrical or electromagnetic signals between communication devices via a transmission link. In general, a data transmission link is usually implemented to support multiple users using the link at the same time. For example, a communication channel of the transmission link may be divided into a plurality of sub-channels each having an allocated bandwidth such that each user may communicate using the same channel without interfering each other.

Transmission resources are usually limited or restricted. However, with a growth of the number of users, the resources may be exhausted. An approach may be adopted by further narrowing the allocated bandwidth for each user so as to allow a larger number of users to communicate using the same channel, while degrading the quality or the transmission efficiency of each of the sub-channels.

### SUMMARY OF THE INVENTION

In accordance with a first aspect of the present invention, there is provided a method for transmitting data over a communication network, comprising the steps of:
selectively splitting a traffic demand of a transmission link into a plurality of portions of traffic demands distributed over a main channel and at least one auxiliary channel of the communication network;
determining a data transmission relationship associated with the traffic demands of the transmission link and at least one parameter of both the main channel and the at least one auxiliary channel; and
transmitting data over one or more of the main channel and the at least one auxiliary channel according to the data transmission relationship.

In an embodiment of the first aspect, the at least one parameter of the at least one auxiliary channel includes an interference in the at least one auxiliary channel which occurs when the data is transmitted over the at least one auxiliary channel.

In an embodiment of the first aspect, the interference is uncontrollable.

In an embodiment of the first aspect, the at least one parameter is associated with a transmission resource allocation of both the main channel and the at least one auxiliary channel.

In an embodiment of the first aspect, the transmission resource allocation includes at least one of a transmission power of the data, a data transmission rate, a channel power gain and a bandwidth of each of the main channel and the at least one auxiliary channel.

In an embodiment of the first aspect, the data transmission relationship is further associated with an outage-probability when at least a portion of the data is transmitted over the at least one auxiliary channel.

In an embodiment of the first aspect, the outage-probability is associated with the transmission resource allocation of the at least one auxiliary channel.

In an embodiment of the first aspect, the outage-probability is represented by:

$${P}_{o} ( {p}_{A} , {r}_{A} ) = Probability \{ {W}_{A} {log}_{2} ( 1 + \frac{{p}_{A} {g}_{A}}{{n}_{A} + {I}_{A}} ) < {r}_{A} \} ,$$

wherein:
p_{A} denotes a transmission power of the data over the at least one auxiliary channel;
r_{A} denotes a data transmission rate over the at least one auxiliary channel;
g_{A} denotes a channel power gain of the at least one auxiliary channel;
n_{A} denotes a power of a background noise of the at least one auxiliary channel;
W_{A} denotes a bandwidth of the at least one auxiliary channel; and
I_{A} represents a random interference.

In an embodiment of the first aspect, the outage-probability is further associated with a power of random interference M_{A} following an on-off distribution represented by:

Probability{I_{A}=M_{A}}=θ_{A} and Probability{I_{A}=0}=1−θ_{A}; and

wherein θ_{A} represents a presence of the interference in the at least one auxiliary channel.

In an embodiment of the first aspect, the outage-probability is represented by:

$${P}_{o} ( {p}_{A} , {r}_{A} ) = {θ}_{A} I ( {M}_{A} + {n}_{A} > \frac{{p}_{A} {g}_{A}}{{2}^{\frac{{r}_{A}}{{W}_{A}}} - 1} ) + ( 1 - {θ}_{A} ) I ( {n}_{A} > \frac{{p}_{A} {g}_{A}}{{2}^{\frac{{r}_{A}}{{W}_{A}}} - 1} ) ,$$

and wherein I(x) represents an indicator function.

In an embodiment of the first aspect, the main channel is a licensed channel and the at least one auxiliary channel is an unlicensed channel.

In accordance with a second aspect of the present invention, there is provided a communication system comprising:
a processing module arranged to selectively split a traffic demand of a transmission link into a plurality of portions of traffic demands distributed over a main channel and at least one auxiliary channel of the communication network, and the processing module is further arranged to determine a data transmission relationship associated with the traffic demand of the transmission link and at least one parameter of both the main channel and the at least one auxiliary channel; and
a transmission module arranged to transmit data over one or more of the main channel and the at least one auxiliary channel according to the data transmission relationship.

In an embodiment of the second aspect, the at least one parameter of the at least one auxiliary channel includes an interference in the at least one auxiliary channel which occurs when the data is transmitted over the at least one auxiliary channel.

In an embodiment of the second aspect, the interference in the at least one auxiliary channel is uncontrollable.

In an embodiment of the second aspect, the at least one parameter is associated with a transmission resource allocation of both the main channel and the at least one auxiliary channel.

In an embodiment of the second aspect, the transmission resource allocation includes at least one of a transmission power of the data, a data transmission rate, a channel power gain and a bandwidth of each of the main channel and the at least one auxiliary channel.

In an embodiment of the second aspect, the data transmission relationship is further associated with an outage-probability when at least a portion of the data is transmitted over the at least one auxiliary channel.

In an embodiment of the second aspect, the outage-probability is associated with the transmission resource allocation of the at least one auxiliary channel.

In an embodiment of the second aspect, the main channel is a licensed channel and the at least one auxiliary channel is an unlicensed channel.

In an embodiment of the second aspect, the communication system further comprises a base station arranged to communicate over the main channel and at least one access point arranged to communicate over the at least one auxiliary channel.

### BRIEF DESCRIPTION OF THE DRAWINGS

Embodiments of the present invention will now be described, by way of example, with reference to the accompanying drawings in which:

FIG. 1 is a schematic diagram of a computing system for operation as a processing module of a communication system in accordance with one embodiment of the present invention;

FIG. 2 is a block diagram of a communication system in accordance with an embodiment of the present invention;

FIG. 3 is an illustration of an operation of the communication system of FIG. 2 with multiple communication devices;

FIG. 4A is a plot showing a data transmission relationship determined by the processing module of the communication system of FIG. 2 with the parameter μ=0.001;

FIG. 4B is a plot showing a data transmission relationship determined by the processing module of the communication system of FIG. 2 with the parameter μ=0.002;

FIG. 5A is a plot showing a data transmission relationship determined by the processing module of the communication system of FIG. 2 with the parameters θ_{A}=0.8 and R^{req}=15 Mbps; and

FIG. 5B is a plot showing a data transmission relationship determined by the processing module of the communication system of FIG. 2 with the parameters θ_{A}=0.8 and R^{req}=16 Mbps.

### DETAILED DESCRIPTION OF THE PREFERRED EMBODIMENT

The inventors have, through their own research, trials and experiments, devised that offloading mobile users' (MUs') data to small-cell networks may relieve traffic congestion in cellular access networks and improve MUs' service quality with the growth of MUs' traffic demands. Exploiting multiple radio-interfaces equipped by most smart devices, there is a growing momentum in both standardizing activities and industrial practices for supporting MUs' traffic offloading, e.g., through the advanced dual-connectivity (DC) that enables an MU to communicate with a macro base station (BS) and offload data to a small-cell access point (AP) simultaneously.

Offloading MUs' data to small-cell APs also involves spectrum usage. For saving spectrum usage, exploiting unlicensed spectrums (which are completely free to use) for providing traffic-offloading services may be preferable. However, due to the open access of unlicensed spectrums, data offloading over unlicensed spectrums may suffer from uncontrollable interference, which thus necessitates a careful design of the MU's resource allocations for meeting its traffic-offloading demand.

In one example embodiment, an MU decides to offload part of its traffic demand to a small-cell AP over unlicensed spectrum. Due to the uncontrollable interference, the MU's offloaded data might not be successfully delivered (i.e., an offloading-outage occurs), which leads to a waste of MU's transmit-power to the AP. Particularly, the probability of offloading-outage strongly depends on the MU's offloading-rate and its radio resource allocations (such as transmit-power). Therefore, it is important to investigate how the MU's offloading-rate over the unlicensed spectrum may be appropriately scheduled by taking into account the uncontrollable interference so as to allocate the MU's transmit-powers to the AP and to the BS to meet its offloading demand as well as service-quality.

Preferably, an outage-probability is evaluated to quantify the adverse influence due to suffering interference when offloading data, and a joint rate-splitting and power allocation problem is formulated to minimize a system-wise cost accounting for the MU's total power consumption and the BS's licensed channel usage. Despite the non-convexity of the joint optimization problem, it may be transformed into three rate-allocation problems under different cases and the respective optimal solutions may be derived, which may be further derived as a globally optimal solution for the original problem. The inventors have also obtained numerical results which validate the derived optimal offloading-solution and show its performance gain.

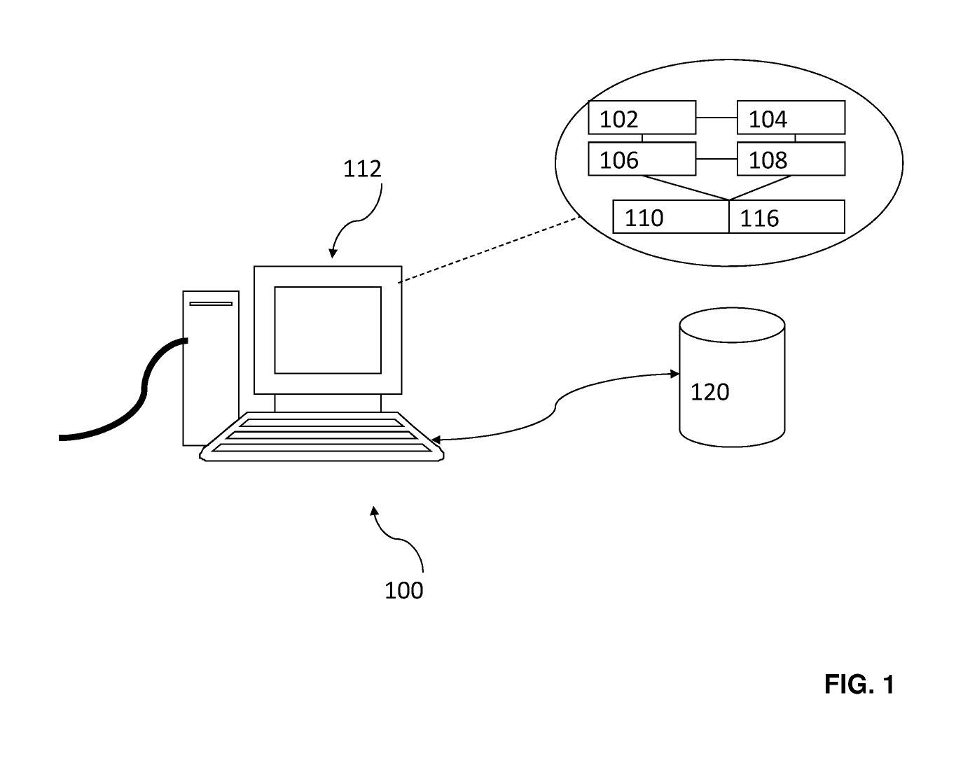

With reference to FIG. 1, an embodiment of the present invention is illustrated. This embodiment is arranged to provide a communication system comprising: a processing module 202 arranged to selectively split a traffic demand of a transmission link into a plurality of portions of traffic demands distributed over a main channel and at least one auxiliary channel of the communication network, and the processing module 202 is further arranged to determine a data transmission relationship associated with the traffic demand of the transmission link and at least one parameter of both the main channel and the at least one auxiliary channel; and a transmission module arranged to transmit data over one or more of the main channel and the at least one auxiliary channel according to the data transmission relationship.

In this embodiment, the processing module 202 is implemented by or for operation on a computer having an appropriate user interface. The computer may be implemented by any computing architecture, including stand-alone PC, client/server architecture, “dumb” terminal/mainframe architecture, or any other appropriate architecture. The computing device is appropriately programmed to implement the invention.

Referring to FIG. 1, there is a shown a schematic diagram of a computer or a computer system 100 arranged to operate, at least in part if not entirely, the processing module 202 of a communication system in accordance with one embodiment of the invention. The computer system 100 comprises suitable components necessary to receive, store and execute appropriate computer instructions. The components may include a processing unit 102, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The computer system 100 includes instructions that may be included in ROM 104, RAM 106 or disk drives 108 and may be executed by the processing unit 102. There may be provided a plurality of communication links 114 which may variously connect to one or more computing devices such as a computer system, personal computers, terminals, wireless or handheld computing devices. At least one of a plurality of communications link may be connected to an external computing network through a telephone line or other type of communications link.

The computer system 100 may include storage devices such as a disk drive 108 which may encompass solid state drives, hard disk drives, optical drives or magnetic tape drives. The computer system 100 may use a single disk drive or multiple disk drives. The computer system 100 may also have a suitable operating system 116 which resides on the disk drive or in the ROM of the computer system 100.

The computer system 100 has a database 120 residing on a disk or other storage device which is arranged to store at least one record 122. The database 120 is in communication with the computer system 100 with an interface, which is implemented by computer software residing on the computer system 100. Alternatively, the database 120 may also be implemented as a stand-alone database system in communication with the computer system 100 via an external computing network, or other types of communication links.

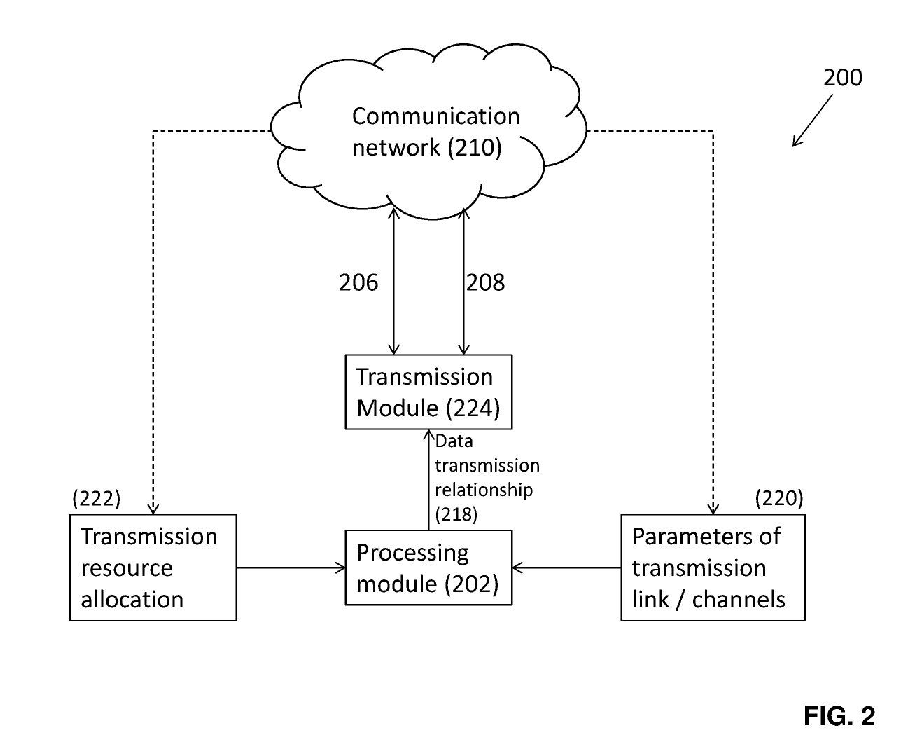

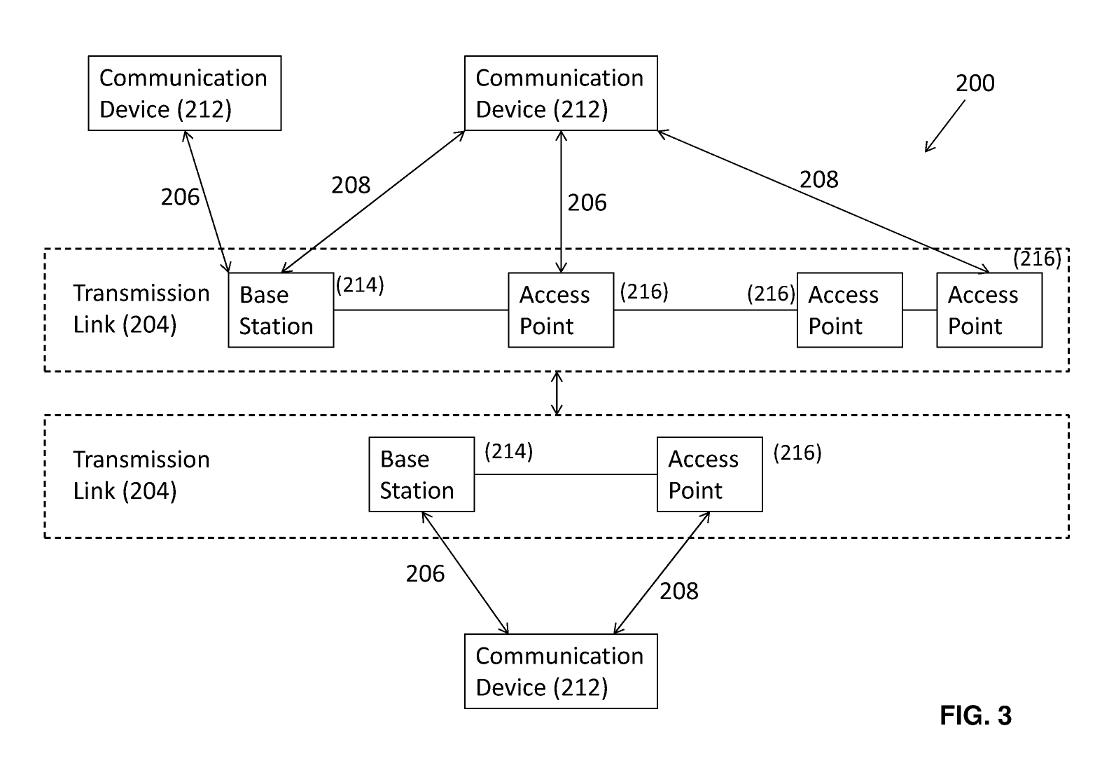

With reference to FIGS. 2 and 3, there is shown an embodiment of the communication system 200. In this embodiment, the computer system 100 is used as part of the communication system 200 as an processing module 202 arranged to selectively split a traffic demand of a transmission link 204 into a plurality of portions of traffic demands distributed over a main channel 206 and at least one auxiliary channel 208 of the communication network 210. This may involve an intelligent process which adjusts a ratio between portions of network traffic to be transmitted over available channels, such as licensed/unlicensed (private/public) channels in a communication network 210, so as to enhance the quality and/or the capacity of the transmission link 204. In some examples, communication channels are distributed over different range of electromagnetic spectrums of frequencies in a communication network 210.

Preferably, referring to FIG. 3, the communication system 200 may comprise or supports one or more communication devices 212 to communicate with other communication devices 212 arranged to communicate via the same transmission link 204 and/or other transmission links 204. The transmission link 204 may comprises a base station 214 arranged to communicate over the main channel 206 and at least one access point 216 arranged to communicate over at least one different auxiliary channel 208.

The main channel 206 is preferably a licensed channel which may be utilized only by the assigned operator(s) or service provider(s), therefore the assigned operator(s) or service provider(s) may implement network infrastructures which may facilitate the communication over such main channel 206 with controllable parameters of the communication system 200.

On the other hand, the at least one auxiliary channel 208 may be one or more unlicensed channels and may be used freely by the public and may be used by multiple operator(s) or service provider(s) at the same time. Therefore, uncontrollable interference may occur when multiple users/communication devices 212 is communicating over the same auxiliary channel 208 at the same time, and may experience failure or outage of communication or data transmission, therefore degrading the overall traffic demand or effective bandwidth of the transmission link 204 due to the outage caused by interference.

Preferably, the processing module 202 may be further arranged to determine a data transmission relationship 218 associated with the traffic demand of the transmission link 204 and at least one parameter of both the main channel 206 and the at least one auxiliary channel 208. The data transmission relationship 218 may include transmission resource allocation 222, uplink/downlink transmission rate and/or other parameters 220 determined by the processing module 202 which are most suitable for maximizing the performance of the data transmission over the main channel 206 and/or the auxiliary channel 208.

In the example embodiments discussed in the later parts of the disclosure, the data transmission relationship 218 is determined and evaluated according to different traffic demand requirements and scenarios.

Alternatively, the processing module 202 may be implemented with processor units, such as but not limited to a microprocessor, an application-specific integrated circuit (ASIC), an application-specific instruction set processor (ASIP), a digital signal processor (DSP), a (field) programmable gate array (FGPA) and a programmable logic device (PLD), and with or without other electrical/electronic components such as switches and memory devices.

In addition, the communication system 200 may also comprise a transmission module 224 arranged to transmit data over one or more of the main channel 206 and the at least one auxiliary channel 208 according to the data transmission relationship 218. The transmission module 224 may be implemented as the data transmission devices in a base station 214 or an access point 216 so as to communicate over the main channel 206 or the auxiliary channel 208 respectively. Alternatively, the transmission module 224 may be implemented in the communication device of the mobile user such that the communication device may communicate with the base station 214 and the access point(s) 216 over the main channel 206 and the auxiliary channel(s) 208 respectively.

In accordance with one example embodiment of the present invention, the method for transmitting data over a communication network 210, comprising the steps of:
selectively splitting a traffic demand of a transmission link 204 into a plurality of portions of traffic demands distributed over a main channel 206 and at least one auxiliary channel 208 of the communication network 210;
determining a data transmission relationship 218 associated with the traffic demands of the transmission link 204 and at least one parameter of both the main channel 206 and the at least one auxiliary channel 208; and
transmitting data over one or more of the main channel 206 and the at least one auxiliary channel 208 according to the data transmission relationship 218.

In this embodiment, as an initial step to investigate the MU's data offloading over unlicensed spectrum or an auxiliary channel, an illustrative scenario in which a representative small-cell AP 216 coexists with a macro BS 214 to provide data offloading service to a targeted MU is considered. The MU intelligently splits its uplink traffic demand R^{req} into two parts, i.e., one part for sending to the BS 214 and the other for offloading to the AP 216.

Preferably, the main channel 206 and the at least one auxiliary channel 208 each may operate with at least one parameter. These parameters may be provided by the base station 214/access point 216 or the transmission link 204 facilitated by the operation of the BS 214/AP 216. For example, these parameters may include a transmission resource allocation 222 of one or both of the main channel 206 and the auxiliary channel 208, such as but not limited to a transmission power of the data, a data transmission rate, a channel power gain and a bandwidth of each of the main channel 206 and the one auxiliary channel(s) 208. The parameters may also include interference in one or both of the main channel 206 and the auxiliary channel 208 which occurs when data is transmitted over the communication channels 206/208.

The transmission resource allocation 222 and/or other parameters of the transmission link 204 may be predetermined or assigned according of the implementation of the communication network 210 or the transmission link 204. Alternatively, these parameters may be dynamically obtained and processed by the processing module 202 during the operation of the transmission link 204 or the communication network 210.

The BS assigns the MU a licensed channel (main channel) of bandwidth W_{B} for use, and the uplink data (data transmission) rate from the MU to the BS, which is denoted by r_{B}, can be given by:

$${r}_{B} = {W}_{B} {log}_{2} ( 1 + \frac{{p}_{B} {g}_{B}}{{n}_{B}} ) , \qquad ( 1 )$$

where p_{B} denotes the MU's transmit-power to the BS, g_{B} denotes the channel power gain from the MU to the BS, and n_{B} denotes the power of the background noise at the BS.

Preferably, the data transmission relationship 218 is further associated with an outage-probability when at least a portion of the data is transmitted over the at least one auxiliary channel 208, and the outage-probability is associated with the transmission resource allocation 222 of the at least one auxiliary channel 208.

Different from the BS, the AP uses an unlicensed channel to accommodate the MU's offloaded data. Due to the open access of the unlicensed channel, the MU might suffer from an uncontrollable or random interference (e.g., due to the transmission of another user who happens to share the same unlicensed channel). This results in that the MU's achievable instantaneous rate to the AP becomes a random variable. To account for this effect, p_{A} is used to denote the MU's transmit-power to AP and r_{A} is used to denote the assigned offloading-rate. Then, the outage-probability, i.e., the MU's assigned offloading-rate r_{A} falling below its achievable instantaneous rate to the AP, can be given by:

$${P}_{o} ( {p}_{A} , {r}_{A} ) = Probability \{ {W}_{A} {log}_{2} ( 1 + \frac{{p}_{A} {g}_{A}}{{n}_{A} + {I}_{A}} ) < {r}_{A} \} ,$$

where W_{A} denotes the bandwidth of the AP's unlicensed channel (the auxiliary channel), and I_{A} represents the random interference, g_{A} denotes the channel power gain from the MU to the AP, and n_{A} denotes the power of the background noise at the AP.

$${W}_{A} {log}_{2} ( 1 + \frac{{p}_{A} {g}_{A}}{{n}_{A} + {I}_{A}} )$$

represents the MU's achievable instantaneous rate to the AP. As a preliminary study, it is assumed that I_{A} follows an on-off distribution as follows:

Probability{I_{A}=M_{A}}=θ_{A} and Probability{I_{A}=0}=1−θ_{A} (2)

where parameter M_{A} denotes the power of random interference and θ_{A} represents a presence of the interference in the at least one auxiliary channel. Notice that the assumed distribution in (2) is meaningful, since it captures the presence (or absence) of another user who happens to use the same unlicensed channel.

With (2) and some further manipulations, the MU's outage-probability when offloading data to the AP is given by:

$${P}_{o} ( {p}_{A} , {r}_{A} ) = {θ}_{A} I ( {M}_{A} + {n}_{A} > \frac{{p}_{A} {g}_{A}}{{2}^{\frac{{r}_{A}}{{W}_{A}}} - 1} ) + ( 1 - {θ}_{A} ) I ( {n}_{A} > \frac{{p}_{A} {g}_{A}}{{2}^{\frac{{r}_{A}}{{W}_{A}}} - 1} ) , \qquad ( 3 )$$

where I(x) represents the indicator function, i.e., I(x)=1 if condition x is true, and I(x)=0, otherwise.

Preferably, the MU has a quality of service to meet in terms of achieving a required uplink rate R^{req}, which based on the outage-probability when offloading data to the AP, corresponds to the following constraint:

r_{B}+r_{A}(1−P₀(r_{A},P_{A}))≧R^{req} (4)

Preferably, the MU's uplink rate r_{B} and the transmit-power p_{B} to the BS, and its offloading-rate r_{A} and the transmit-power p_{A} to the AP are jointly optimized. In addition, the optimization may minimize a cost function that accounts for the MU's power consumption and the use of the BS's licensed channel. Therefore, an Energy-Aware Cost Minimization Problem (EACMP) may be provided as follows:

(EACMP): min p_{A}+p_{B}+μI(r_{B}>0),

subject to: constraints (1), (3), and (4),
0≦p_{A}≦P_{A}^{max},
0≦p_{B}≦P_{B}^{max},
r_{A}≧0 and r_{B}≧0,
variables: (p_{A},r_{A}) and (p_{B},r_{B}).

The objective function includes two parts: p_{A}+p_{B} denotes the MU's total power consumption, and μI (r_{B}>0) denotes the cost due to using the BS's licensed channel (i.e., a nonzero rate to the BS is invoked), with μ denoting the unit cost.

The dis-continuity of the objective function and constraint (3) makes Problem (EACMP) nonconvex and may be difficult to solve. In accordance with the following embodiments, different cases of Problem (EACMP) are characterized and optimal solutions for each case are derived.

To solve Problem (EACMP), relationship (3) is first analysed, which, after some manipulations, can be re-expressed as follows:

$${P}_{o} ( {r}_{A} , {p}_{A} ) = \{ \begin{matrix}0 , & if {p}_{A} \geq \frac{{M}_{A} + {n}_{A}}{{g}_{A}} ( {2}^{\frac{{r}_{A}}{{W}_{A}}} - 1 ) , \\ θ , & if \frac{{M}_{A} + {n}_{A}}{{g}_{A}} ( {2}^{\frac{{r}_{A}}{{W}_{A}}} - 1 ) > {p}_{A} \geq \frac{{n}_{A}}{{g}_{A}} ( {2}^{\frac{{r}_{A}}{{W}_{A}}} - 1 ) , \\ 1 , & if {p}_{A} < \frac{{n}_{A}}{{g}_{A}} ( {2}^{\frac{{r}_{A}}{{W}_{A}}} - 1 ) .\end{matrix}$$

Based on the above Pₒ(r_{A},p_{A}), the following result regarding Problem (EACMP) may be obtained.

Proposition 1:

Any optimal solution of Problem (EACMP) satisfies one of the following three cases:

$$\underline{CaseI} \text{:} {P}_{o} ( {r}_{A}^{*} , {p}_{A}^{*} ) = 0 ⇒ {p}_{A}^{*} = \frac{{M}_{A} + {n}_{A}}{{g}_{A}} ( {2}^{\frac{{r}_{A}^{*}}{{W}_{A}}} - 1 ) ;$$

$$\underline{CaseII} \text{:} {P}_{o} ( {r}_{A}^{*} , {p}_{A}^{*} ) = {θ}_{A} ⇒ {p}_{A}^{*} = \frac{{n}_{A}}{{g}_{A}} ( {2}^{\frac{{r}_{A}^{*}}{{W}_{A}}} - 1 ) ;$$

$$\underline{CaseIII} \text{:} {P}_{o} ( {r}_{A}^{*} , {p}_{A}^{*} ) = 1 ⇒ {p}_{A}^{*} = 0 and {r}_{A}^{*} = 0.$$

Proof:

The proof is based on showing contradiction, which is skipped here due to the space limitation. In particular, in Case III, Pₒ(r*_{A},p*_{A})=1 indicates that the MU's offloading to the AP is completely useless. Thus, r*_{A} could be an arbitrary nonnegative value. For clarity, it is preferable to set r*_{A}=0 in Case III, which will not influence the minimum total cost as well as all the other optimal solutions.

Based on Proposition 1, the Problem (EACMP) under Case I, Case II, and Case III may be solved individually.

Case I corresponds to Pₒ(r*_{A},p*_{A})=0, which leads to r_{B}=R^{req}−r_{A} (i.e., constraint (4)). Further based on (1), the MU's transmit-power p_{B} to the BS, as a function of the MU's offloading-rate r_{A}, can be given by:

$${p}_{B} = ( {2}^{\frac{{R}^{req} - {r}_{A}}{{W}_{B}}} - 1 ) \frac{{n}_{B}}{{g}_{B}} . \qquad ( 5 )$$

Using (7), the following cost function representing the MU's total power consumption under Case I is introduced:

$${C}_{CaseI} ( {r}_{A} ) = ( {2}^{\frac{{r}_{A}}{{W}_{A}}} - 1 ) \frac{{M}_{A} + {n}_{A}}{{g}_{A}} + ( {2}^{\frac{{R}^{req} - {r}_{A}}{{W}_{B}}} - 1 ) \frac{{n}_{B}}{{g}_{B}}$$

Problem (EACMP) can be equivalently transformed into the following one (which only involves r_{A} as a decision variable):

$$\begin{matrix}\underline{( EACMP \text{-} CaseI ) \text{:}} { min}_{{r}_{A}} {C}_{CaseI} ( {r}_{A} ) + μ I ( {r}_{A} < {R}^{req} ) \\ subject to \text{:} 0 \leq {r}_{A} \leq {R}^{req} , \\ ( {2}^{\frac{{r}_{A}}{{W}_{A}}} - 1 ) \frac{{M}_{A} + {n}_{A}}{{g}_{A}} \leq {P}_{A}^{max} , & ( 6 ) \\ ( {2}^{\frac{{R}^{req} - {r}_{A}}{{W}_{B}}} - 1 ) \frac{{n}_{B}}{{g}_{B}} \leq {P}_{B}^{max} . & ( 7 )\end{matrix}$$

constraints (6) and (7) together lead to:

r_{A,CaseI}^{low}≦r_{A}≦r_{A,CaseI}^{upp},

where r_{A,CaseI}^{upp}, which stems from (6), is given by:

$${r}_{A , CaseI}^{upp} = {W}_{A} {log}_{2} ( \frac{{P}_{A}^{max} {g}_{A}}{{n}_{A} + {M}_{a}} + 1 ) ,$$

and r_{A,caseI}^{low}, which stems from (7), is given by:

$${r}_{A , CaseI}^{low} = max \{ {R}^{req} - {W}_{B} {log}_{2} ( \frac{{P}_{B}^{max} {g}_{B}}{{n}_{B}} + 1 ) , 0 \} .$$

With r_{A,CaseI}^{low}, and r_{A,caseI}^{upp}, Problem (EACMP-CaseI) can be re-expressed as follows (where “E” represents “Equivalence”):

$$\underline{( EACMP \text{-} CaseI \text{-} E ) \text{:}} { min}_{{r}_{A}} {C}_{CaseI} ( {r}_{A} ) + μ I ( {r}_{A} < {R}^{req} )$$

$$subject to \text{:} {r}_{A , CaseI}^{low} \leq {r}_{A} \leq min \{ {R}^{req} , {r}_{A , CaseI}^{upp} \} .$$

Despite the discontinuity of the objective function, the optimal solution of Problem (EACMP-CaseI-E) may be derived.

Proposition 2:

If r_{A,caseI}^{low}≦min{R^{req},r_{A,CaseI}^{upp}}, the optimal solution of Problem (EACMP-CaseI-E) (equivalently, Problem (EACMP-CaseI)) can be given by:

$${r}_{A , CaseI}^{*} = \{ \begin{matrix}{R}^{req} , & \begin{matrix}if {C}_{CaseI} ( {\hat{r}}_{A , CaseI} ) + μ > {C}_{CaseI} ( {R}^{req} ) and \\ \frac{{M}_{A} + {n}_{A}}{{g}_{A}} ( {2}^{\frac{{R}^{req} - {r}_{A}}{{W}_{A}}} - 1 ) \leq {P}_{A}^{max}\end{matrix} , \\ {\hat{r}}_{A , CaseI} , & otherwise .\end{matrix} \qquad ( 8 )$$

Specifically, \hat{r}_{A,CaseI} in (8) is given by:

$${\hat{r}}_{A , CaseI} = {[ {r}_{A , CaseI}^{root} ]}_{{r}_{A , CaseI}^{low}}^{min \{ {R}^{req} - δ , {r}_{A , CaseI}^{upp} \}} ,$$

where [x]ₐ^{b}=min{max{x,a},b}, and r_{A,caseI}^{root} is given by:

$${r}_{A , CaseI}^{root} = \frac{{W}_{A} {R}^{req}}{( {W}_{B} + {W}_{A} )} - \frac{{W}_{B} {W}_{A}}{{W}_{B} + {W}_{A}} {log}_{2} \frac{( {M}_{A} + {n}_{A} ) {W}_{B} {g}_{B}}{{n}_{B} {W}_{A} {g}_{A}} . \qquad ( 9 )$$

Parameter δ is a very small positive number to exclude \hat{r}_{A,CaseI}=R^{req}. However, if r_{A,CaseI}^{low}>min{R^{req},r_{A,CaseI}^{upp}}, Problem Problem (EACMP-CaseI-E) is infeasible, i.e., Case I cannot yield any feasible solution for Problem (EACMP).

Proof:

It is easy to see that Problem (EACMP-CaseI-E) is infeasible if r_{A,CaseI}^{low}>min{R^{req},r_{A,CaseI}^{upp}}. The next step is to process on r_{A,CaseI}^{low}≦min{R^{req},r_{A,extCaseI}^{upp}}. To derive the optimal solution, it is necessary to consider the following two possible situations, i.e., (Situation 1): the optimal solution r*_{A}<R^{req}, and (Situation 2): r*_{A}=R^{req}. By comparing the respective minimum total costs under Situation 1 and Situation 2, thus the optimal solution of Problem (EACMP-CaseI-E) can be determined.

In an example Situation 1 where r*_{A}<R^{req}, it is first assumed that r*_{A}<R^{req} holds. Thus, Problem (EACMP-CaseI-E) becomes:

$$\underline{( EACMP \text{-} CaseI \text{-} E \text{-} S 1 )} \text{:} { min}_{{r}_{A}} F ( {r}_{A} ) = {C}_{CaseI} ( {r}_{A} ) + μ$$

$$subject to \text{:} {r}_{A , CaseI}^{low} \leq {r}_{A} \leq min \{ {R}^{req} - δ , {r}_{A , CaseI}^{upp} \} ,$$

where δ is a very small positive number to ensure r_{A}<R^{req}.

A close look at Problem (EACMP-CaseI-E-S1) shows that it is a strictly convex optimization problem, since

$$\frac{d F ( {r}_{A} )}{d {r}_{A}} = \frac{{M}_{A} + {n}_{A}}{{W}_{A} {g}_{A}} {2}^{\frac{{r}_{A}}{{W}_{A}}} ln 2 - \frac{{n}_{B}}{{W}_{B} {g}_{B}} {2}^{\frac{{R}^{req} - {r}_{A}}{{W}_{B}}} ln 2 , \qquad ( 10 )$$

is increasing in r_{A}. Based on the convex optimization theory, Problem (EACMP-CaseI-E-S1) is a convex optimization.

The convexity of Problem (EACMP-CaseI-E-S1) enables the optimal solution to be derived analytically. Specifically, the unique root for

$$\frac{dF ( {r}_{A} )}{{r}_{A}} = 0$$

may be derived as r_{A,CaseI}^{root} in (9). By further taking into account r_{A}ε[r_{A,CaseI}^{low},min{R^{req}−δ,r_{A,CaseI}^{upp}}] in Situation 1, the optimal solution of (EACMP-CaseI-E-S1) may be derived as follows:

$${r}_{A , CaseI}^{*} = {\hat{r}}_{A , CaseI} = {[ {r}_{k , CaseI}^{root} ]}_{{r}_{A , CaseI}^{low}}^{min \{ {R}^{req} - δ , {r}_{A , CaseI}^{upp} \}} .$$

Correspondingly, the minimum total system case under Situation 1 is given by C_{CaseI}(\hat{r}_{A,CaseI})+μ.

In an example Situation 2 where r*_{A}=R^{req}, the solution of Problem (EACMP-CaseI-E) is trivially given by:

$${r}_{A , CaseI}^{*} = {R}^{req} , if \frac{{M}_{A} + {n}_{A}}{{g}_{A}} ( {2}^{\frac{{R}^{req}}{{W}_{A}}} - 1 ) \leq {P}_{A}^{max} . \qquad ( 11 )$$

Correspondingly, the minimum total system cost under

Situation 2 is given by C_{CaseI}(R^{req}) Notice that according to definition of r_{A,CaseI}^{upp}, the condition

$$\frac{{M}_{A} + {n}_{A}}{{g}_{A}} ( {2}^{\frac{{R}^{req}}{{W}_{A}}} - 1 ) \leq {P}_{A}^{max}$$

is equivalent to R^{req}≦r_{A,CaseI}^{upp}.

By comparing the respective derived minimum system costs under Situation 1 and Situation 2, the optimal solution of Problem (EACMP-CaseI-E) can be derived.

If C_{CaseI}(R^{req}<C_{CaseI}(\hat{r}_{A,CaseI})+μ and

$$\frac{{M}_{A} + {n}_{A}}{{g}_{A}} ( {2}^{\frac{{R}^{req}}{{W}_{A}}} - 1 ) \leq {P}_{A}^{max}$$

(i.e., r_{A}=R^{req} is a feasible solution), then the optimal solution of Problem(EACMP-CaseI-E) is given by the first case of eq. (8). Otherwise, the optimal solution of Problem (EACMP-CaseI-E) is given by the second case of eq. (8).

Based on r*_{A,CaseI} in (8), the corresponding optimal solution of Problem (EACMP) may be further derived as follows.

Proposition 3:

Knowing r*_{A,CaseI} in (12), the optimal solution of Problem (EACMP) under Case I can be given by:

$${r}_{B , CaseI}^{*} = {R}^{req} - {r}_{A , CaseI}^{*} , \\ {p}_{B , CaseI}^{*} = ( {2}^{\frac{{R}^{req} {r}_{A , CaseI}^{*}}{{W}_{B}}} - 1 ) \frac{{n}_{B}}{{g}_{B}} , \\ {p}_{A , CaseI}^{*} = ( {2}^{\frac{{r}_{A , CaseI}^{*}}{{W}_{A}}} - 1 ) \frac{{M}_{A} + {n}_{A}}{{g}_{A}} ,$$

and the minimum total system cost V_{CaseI} under Case I is:

$${V}_{CaseI} = \{ \begin{matrix}{p}_{B , CaseI}^{*} + {p}_{A , CaseI}^{*} + μ I ( {r}_{B , CaseI}^{*} > 0 ) , & if {r}_{A , CaseI}^{low} \leq min \{ {R}^{req} , {r}_{A , CaseI}^{upp} \} \\ ∞ , & otherwise\end{matrix}$$

Notice that the total system cost is infinity when Problem (EACMP) is infeasible.

Proof:

The proof follows by (4), (5) and Proposition 1.

In another example embodiment, the Problem (EACMP) under Case II is solved.

Based on Proposition 1, Case II corresponds to Pₒ(r*_{A},p*_{A})=θ, which leads to r_{B}=R^{req}−r_{A}(1−θ)(i.e., constraint (4)). Further based on (1), the MU' s transmit-power p_{B} to the BS, as a function the MU's offloading-rate r_{A}, can be given by:

$${p}_{B} = ( {2}^{\frac{{R}^{req} {r}_{A} ( 1 - {θ}_{A} )}{{W}_{B}}} - 1 ) \frac{{n}_{B}}{{g}_{B}} . \qquad ( 12 )$$

Using (12), the following cost function to represent the MU's total power consumption under Case II may be introduced:

$${C}_{CaseII} ( {r}_{A} ) = ( {2}^{\frac{{r}_{A}}{{W}_{A}}} - 1 ) \frac{{n}_{A}}{{g}_{A}} + ( {2}^{\frac{{R}^{req} {r}_{A} ( 1 - {θ}_{A} )}{{W}_{B}}} - 1 ) \frac{{n}_{B}}{{g}_{B}} .$$

Problem (EACMP) can be equivalently transformed into the following one (which only involves r_{A} as a decision variable):

$$\begin{matrix}\underline{( EACMP \text{-} CaseII )} \text{:} {min}_{{r}_{A}} {C}_{CaseII} ( {r}_{A} ) + μ I ( {r}_{A} < \frac{{R}^{req}}{1 - {θ}_{A}} ) \\ subject to \text{:} 0 \leq {r}_{A} ( 1 - {θ}_{A} ) \leq {R}^{req} , \\ ( {2}^{\frac{{r}_{A}}{{W}_{A}}} - 1 ) \frac{{n}_{A}}{{g}_{A}} \leq {P}_{A}^{max} , & ( 13 ) \\ ( {2}^{\frac{{R}^{req} {r}_{A} ( 1 - {θ}_{A} )}{{W}_{B}}} - 1 ) \frac{{n}_{B}}{{g}_{B}} \leq {P}_{B}^{max} . & ( 14 )\end{matrix}$$

In particular, (13) and (14) together lead to:

r_{A,CaseII}^{low}≦r_{A}≦r_{A,CaseII}^{upp},

where r_{A,CaseII}^{upp}, which stems from (13), is given by:

$${r}_{A , CaseII}^{upp} = {W}_{A} {log}_{2} ( \frac{{P}_{A}^{max} {g}_{A}}{{n}_{A}} + 1 ) ,$$

and r_{A,caseII}^{low}, which stems from (14), is given by:

$${r}_{A , CaseII}^{low} = max \{ \frac{1}{1 - {θ}_{A}} ( {R}^{req} - {W}_{B} {log}_{2} ( \frac{{P}_{B}^{max} {g}_{B}}{{n}_{B}} + 1 ) ) , 0 \} .$$

With r_{A,CaseII}^{low} and r_{A,CaseII}^{upp}, Problem (EACMP-CaseII) can be re-expressed as follows:

$$\underline{( EACMP \text{-} CaseII \text{-} E )} \text{:} min {C}_{CaseII} ( {r}_{A} ) + μ I ( {r}_{A} < \frac{1}{1 - {θ}_{A}} {R}^{req} )$$

$$subject to \text{:} {r}_{A , CaseII}^{low} \leq {r}_{A} \leq min \{ \frac{1}{1 - {θ}_{A}} {R}^{req} , {r}_{A , CaseII}^{upp} \} .$$

Despite the discontinuity of the objective function, the optimal solution of Problem (EACMP-CaseII-E) may be derived.

$${r}_{A , CaseII}^{low} \leq min \{ \frac{1}{1 - {θ}_{A}} {R}^{req} , {r}_{A , CaseII}^{upp} \} ,$$

Proposition 4:

If then the optimal solution of Problem (EACMP-CaseII-E) (equivalently, Problem (EACMP-CaseII)) can be given by:

$${r}_{A , CaseII}^{*} = \{ \begin{matrix}\frac{{R}^{req}}{1 - {θ}_{A}} , if {C}_{CaseII} ( {\hat{r}}_{A , CaseII} ) + μ > {C}_{CaseII} ( \frac{{R}^{req}}{1 - {θ}_{A}} ) and \\ \frac{{n}_{A}}{{g}_{A}} ( {2}^{\frac{{R}^{req}}{{W}_{A} ( 1 - {θ}_{A} )}} - 1 ) \leq {P}_{A }^{ma x} , \\ {\hat{r}}_{A , CaseII} , otherwise\end{matrix} . \qquad ( 15 )$$

Specifically, \hat{r}_{A,CaseII} in (15) is given by:

$${\hat{r}}_{A , CaseII} = {[ {r}_{A , CaseII}^{root} ]}_{{r}_{A , CaseII}^{low}}^{m i n \{ \frac{1}{1 - {θ}_{A}} {R}^{req} - δ , {r}_{A , CaseII}^{upp} \}}$$

where r_{A,CaseII}^{root} is given by:

$${r}_{A , CaseII}^{root} = \frac{{W}_{A} {R}^{eq}}{{W}_{B} + {W}_{A} ( 1 - {θ}_{A} )} - \frac{{W}_{B} {W}_{A}}{{W}_{B} + {W}_{A} ( 1 - {θ}_{A} )} {log}_{2} \frac{{n}_{A} {W}_{B} {g}_{B}}{{n}_{B} {W}_{A} {g}_{A} ( 1 - {θ}_{A} )}$$

δ again is a very small positive number to exclude

$${\hat{r}}_{A , CaseI} = \frac{{R}^{req}}{1 - {θ}_{A}} .$$

### However, if

$${r}_{A , CaseII}^{low} > min \{ \frac{1}{1 - {θ}_{A}} {R}^{req} , {r}_{A , CaseII}^{upp} \} ,$$

then Problem (EACMP-CaseII-E) is infeasible, i.e., Case II cannot yield any feasible solution for Problem (EACMP).

Proof:

The proof is essentially similar to that of Proposition 2.

Based on r*_{A,caseII} in (15), the optimal solution of Problem (EACMP) under Case II may be further derived as follows.

Proposition 5:

Knowing r*_{A,CaseII}, the optimal solution of Problem (EACMP) under Case II can be given by:

$${r}_{B , CaseII}^{*} = {R}^{req} - {r}_{A , CaseII}^{*} ( 1 - {θ}_{A} ) , \\ {p}_{B , CaseII}^{*} = ( {2}^{\frac{{R}^{req} - {r}_{A , CaseII}^{*} ( 1 - {θ}_{A} )}{{W}_{B}}} - 1 ) \frac{{n}_{B}}{{g}_{B}} , \\ {p}_{A , CaseII}^{*} = ( {2}^{\frac{{r}_{A , CaseII}^{*}}{{W}_{A}}} - 1 ) \frac{{n}_{A}}{{g}_{A}} .$$

and the minimum total system cost under Case II is:

$${V}_{CaseII} = \{ \begin{matrix}{p}_{B , CaseII}^{*} + {p}_{A , CaseII}^{*} + μ I ( {r}_{B , CaseII}^{*} > 0 ) , \\ if {r}_{A , CaseII}^{low} \leq min \{ \frac{1}{1 - {θ}_{A}} {R}^{req} , {r}_{A , CaseII}^{upp} \} , \\ ∞ , otherwise\end{matrix} .$$

Proof:

The proof follows by (4), (12) and Proposition 1.

In yet another example embodiment, the optimal solution problem (EACMP) under Case III is derived. Based on Proposition 1, Case III corresponds to Pₒ(r*_{A},p*_{A})=1, which leads to r_{B}=R^{req} (i.e., constraint (4)). Thus, the optimal solution for Problem (EACMP) under Case III can be trivially derived as follow.

Proposition 6:

If

$$( {2}^{\frac{{R}^{req}}{{W}_{B}}} - 1 ) \frac{{n}_{B}}{{g}_{B}} \leq {P}_{B}^{ma x} ,$$

the optimal solutions of Problem (EACMP) under Case III are given by:

$${r}_{B , CaseIII}^{*} = {R}^{req} , and {p}_{B , CaseIII}^{*} = ( {2}^{\frac{{R}^{req}}{{W}_{B}}} - 1 ) \frac{{n}_{B}}{{g}_{B}} , \\ {r}_{A , CaseIII}^{*} = 0 , and {p}_{A , CaseIII}^{*} = 0.$$

If

$$( {2}^{\frac{{R}^{req}}{{W}_{B}}} - 1 ) \frac{{n}_{B}}{{g}_{B}} > {P}_{B}^{ma x} ,$$

Case III cannot yield any feasible solution for Problem (EACMP). Accordingly, the minimum total cost of Problem (EACMP) under Case III is

$${V}_{CaseIII} = \{ \begin{matrix}{p}_{B , CaseII}^{*} + μ , if {r}_{A , CaseII}^{low} \leq \{ \frac{1}{1 - {θ}_{A}} {R}^{req} , {r}_{A , CaseII}^{upp} \} , \\ ∞ , otherwise\end{matrix} .$$

Proof:

The proof follows by (1), (4), and Proposition 1.

Finally, by comparing the derived minimum total system costs under Case I (Proposition 3), under Case II (Proposition 5), and under Case III (Proposition 6), the globally optimal solution for Problem (EACMP) may be derived as follows.

Proposition 7:

Let z^{o}=arg Min _{zε{CaseI,CaseII,CaseIII}}{V_{z}}. The globally optimal solution for Problem (EACMP) can be given by:

r*_{B}=r*_{B,z}_{^{o}}, p*_{B}=p*_{B,z}_{^{o}}, r*_{A}=r*_{A,z}_{^{o}}, p*_{A}=p*_{A,z}_{^{o}},

In one example embodiment, a network scenario is setup, in which the BS is located at origin (0m,0m), and the AP is located at (250m,0m). It is defined that g_{A}=ρd_{A}^{-λ}, where d_{A} denotes the distance between the MU and the AP, λ denotes the power-scaling factor for the path-loss, and ρ denotes the fading-effect. In addition, W_{A}=20 MHz and W_{B}=5 MHz, and P_{A}^{max}=0.2 W and P_{B}^{max}=0.2 W. Besides, nₒ=1×10⁻¹⁵ W/Hz and M_{A}=3×10⁻⁷ W.

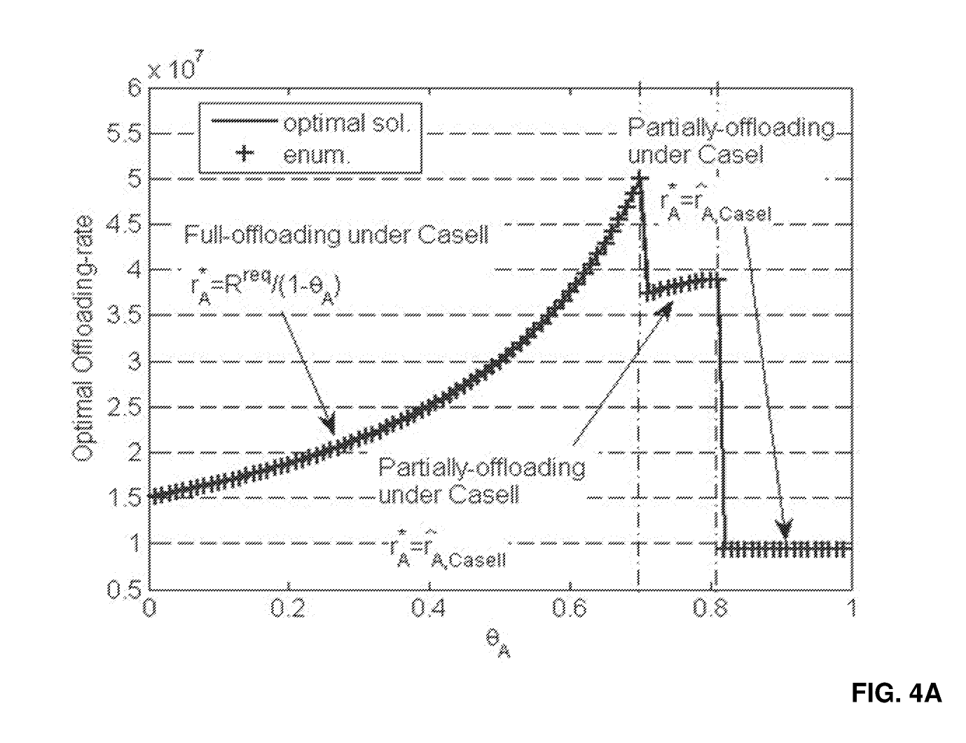

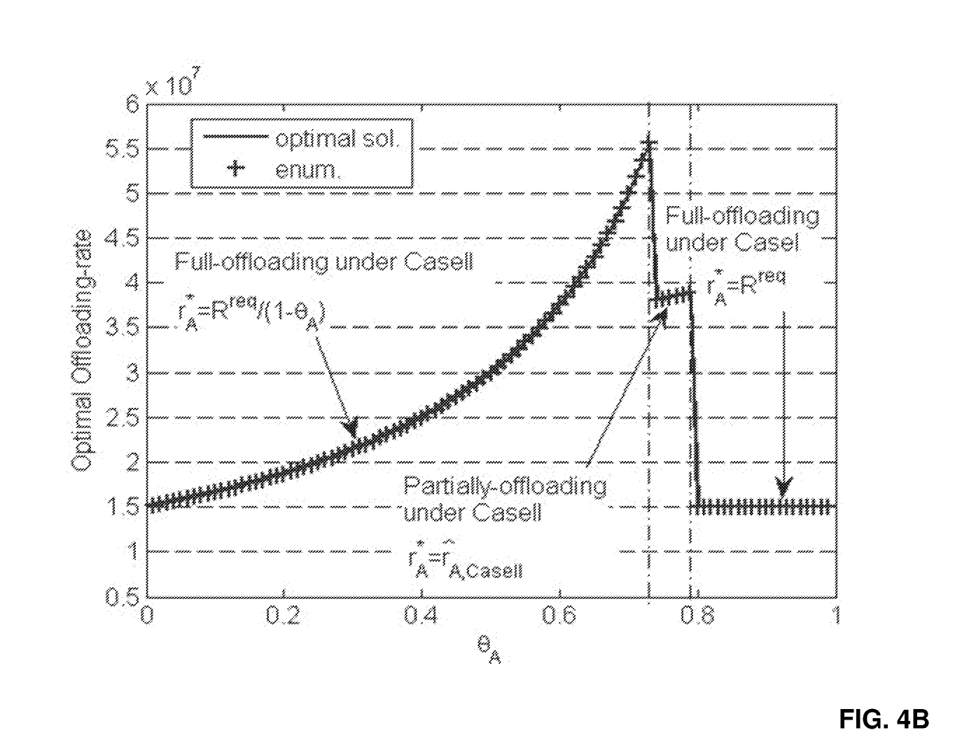

In this embodiment, the derived globally optimal solution was validated. For comparison, the enumeration (i.e., brute-force) method was also used to solve Problem (EACMP) directly. With reference to FIGS. 4A and 4B there is shown the comparison results under different μ and θ_{A}. It is shown on FIGS. 4A and 4B that the derived globally optimal solutions match with those obtained by the enumeration exactly.

In addition, it is also verified that the globally optimal offloading-solution will occur under different cases of Problem (EACMP). Referring to FIGS. 4A and 4B, when θ_{A} is small, the optimal offloading-solution happens under Case II, including the full-offloading, i.e.,

$${r}_{A}^{*} = \frac{{R}^{req}}{1 - {θ}_{A}}$$

and the partial-offloading, i.e.,

$${r}_{A}^{*} < \frac{{R}^{req}}{1 - {θ}_{A}} .$$

This means that the MU opportunistically exploits the unlicensed spectrum by assuming no random interference but sacrificing the resultant outage-probability when offloading data. However, when θ_{A} is large, the optimal offloading-solution happens under Case I, including the full-offloading, i.e., r*_{A}=R^{req} in FIG. 4A and the partial-offloading, i.e., R*_{A}<R^{req} in FIG. 4B.

Advantageously, this means that the MU's transmit-power to the AP fully tackles with the potential interference which yields a zero outage-probability. The comparison between FIGS. 4A and 4B also shows that a larger μ encourages the MU to perform the full-offloading in Case I to avoid the use of the BS's licensed channel.

Theses embodiments may be advantageous in that performance of a transmission link may be enhanced by intelligently and selectively offloading a portion of bandwidth of a transmission link to unlicensed spectrum while considering the impact of random occurrences of interference so as to maintain the desired traffic demand and quality of service (QoS).

Advantageously, the requirements for a base station can be lower when compared to infrastructures which may not support data offloading in accordance with the embodiments of the present invention. Therefore, the cost for implementing the communication system as well as operating such communication system with data offloading features may be reduced. For example, the base station may transmit data with narrower bandwidth and/or lower transmission power.

In addition, multiple APs 216 may be included to support a distribution of traffic demand over multiple auxiliary channel 208s, so as to further enhance the offloading capability so as to further reduce the transmission resource allocation 222 required by the base station 214 or transmission over the main channel 206.

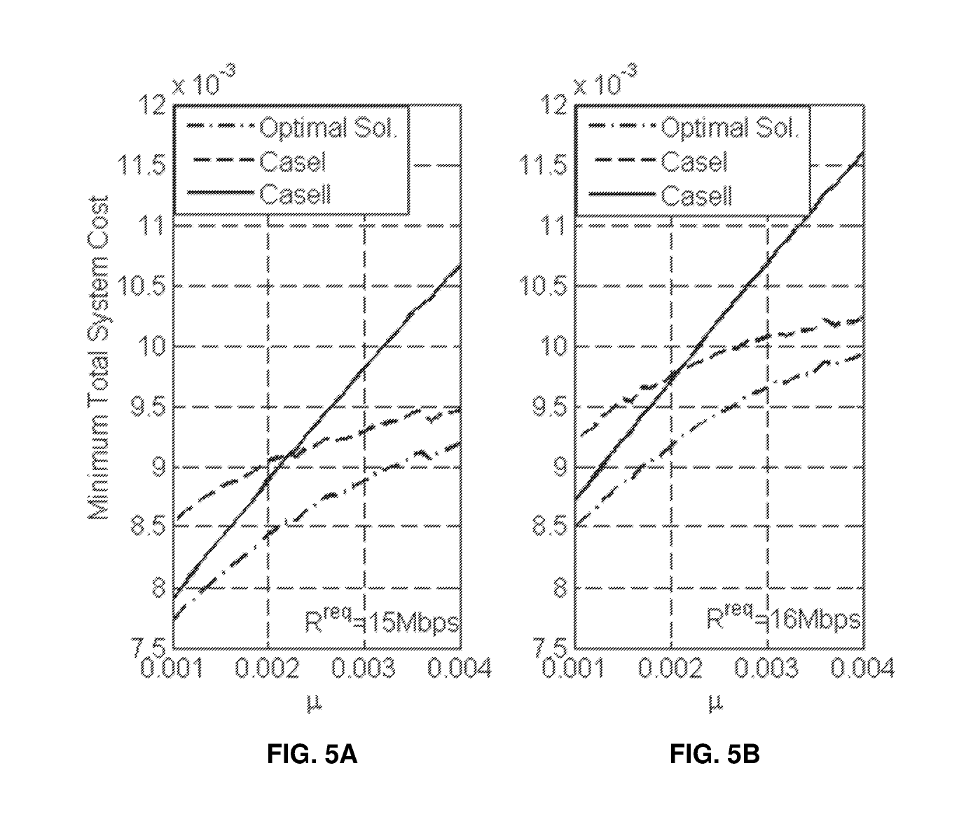

With reference to FIGS. 5A and 5B, there is shown an advantage of optimal data-offloading. The minimum total system cost obtained by the optimal offloading-solution was compared with those obtained by two other heuristic schemes, namely, the one that only accounts for Case I and the one that only accounts for Case II. To make the comparison comprehensive, the MU was set to be randomly located within a circle whose center is (180m,0m) and radius is 20m. μ was varied from 0.001 to 0.004 with a small step-size.

For each μ, the plotted values in FIGS. 5A and 5B represent the average results of 10000 random-samples of the MU's location. It is shown that the optimal offloading significantly reduces the total system cost compared to the two other schemes.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that the term “database” may include any form of organized or unorganized data storage devices implemented in either software, hardware or a combination of both which are able to implement the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method for transmitting data over a communication network, comprising the steps of:
selectively splitting a traffic demand of a transmission link into a plurality of portions of traffic demands distributed over a main channel and at least one auxiliary channel of the communication network;
determining a data transmission relationship associated with the traffic demands of the transmission link and at least one parameter of both the main channel and the at least one auxiliary channel; and
transmitting data over one or more of the main channel and the at least one auxiliary channel according to the data transmission relationship.

2. A method for transmitting data in accordance with claim 1, wherein the at least one parameter of the at least one auxiliary channel includes an interference in the at least one auxiliary channel which occurs when the data is transmitted over the at least one auxiliary channel.

3. A method for transmitting data in accordance with claim 2, wherein the interference is uncontrollable.

4. A method for transmitting data in accordance with claim 1, wherein the at least one parameter is associated with a transmission resource allocation of both the main channel and the at least one auxiliary channel.

5. A method for transmitting data in accordance with claim 4, wherein the transmission resource allocation includes at least one of a transmission power of the data, a data transmission rate, a channel power gain and a bandwidth of each of the main channel and the at least one auxiliary channel.

6. A method for transmitting data in accordance with claim 4, wherein the data transmission relationship is further associated with an outage-probability when at least a portion of the data is transmitted over the at least one auxiliary channel.

7. A method for transmitting data in accordance with claim 6, wherein the outage-probability is associated with the transmission resource allocation of the at least one auxiliary channel.

8. A method for transmitting data in accordance with claim 7, wherein the outage-probability is represented by:
$${P}_{o} ( {p}_{A} , {r}_{A} ) = Probability \{ {W}_{A} {log}_{2} ( 1 + \frac{{p}_{A} {g}_{A}}{{n}_{A} + {I}_{A}} ) < {r}_{A} \} ,$$
wherein:
p_{A} denotes a transmission power of the data over the at least one auxiliary channel;
r_{A} denotes a data transmission rate over the at least one auxiliary channel;
g_{A} denotes a channel power gain of the at least one auxiliary channel;
n_{A} denotes a power of a background noise of the at least one auxiliary channel;
W_{A} denotes a bandwidth of the at least one auxiliary channel; and
I_{A} represents a random interference.

9. A method for transmitting data in accordance with claim 8, wherein the outage-probability is further associated with a power of random interference M_{A} following an on-off distribution represented by:
Probability{I_{A}=M_{A}}=θ_{A} and Probability{I_{A}=0}=1−θ_{A}; and
wherein θ_{A} represents a presence of the interference in the at least one auxiliary channel.

10. A method for transmitting data in accordance with claim 9, wherein the outage-probability is represented by:
$${P}_{o} ( {p}_{A} , {r}_{A} ) = {θ}_{A} I ( {M}_{A} + {n}_{A} > \frac{{p}_{A} {g}_{A}}{{2}^{\frac{{r}_{A}}{{W}_{A}}} - 1} ) + ( 1 - {θ}_{A} ) I ( {n}_{A} > \frac{{p}_{A} {g}_{A}}{{2}^{\frac{{r}_{A}}{{W}_{A}}} - 1} ) ,$$
and wherein I(x) represents an indicator function.

11. A method for transmitting data in accordance with claim 1, wherein the main channel is a licensed channel and the at least one auxiliary channel is an unlicensed channel.

12. A communication system comprising:
a processing module arranged to selectively split a traffic demand of a transmission link into a plurality of portions of traffic demands distributed over a main channel and at least one auxiliary channel of the communication network, and the processing module is further arranged to determine a data transmission relationship associated with the traffic demand of the transmission link and at least one parameter of both the main channel and the at least one auxiliary channel; and
a transmission module arranged to transmit data over one or more of the main channel and the at least one auxiliary channel according to the data transmission relationship.

13. A communication system in accordance with claim 12, wherein the at least one parameter of the at least one auxiliary channel includes an interference in the at least one auxiliary channel which occurs when the data is transmitted over the at least one auxiliary channel.

14. A communication system in accordance with claim 13, wherein the interference in the at least one auxiliary channel is uncontrollable.

15. A communication system in accordance with claim 12, wherein the at least one parameter is associated with a transmission resource allocation of both the main channel and the at least one auxiliary channel.

16. A communication system in accordance with claim 15, wherein the transmission resource allocation includes at least one of a transmission power of the data, a data transmission rate, a channel power gain and a bandwidth of each of the main channel and the at least one auxiliary channel.

17. A communication system in accordance with claim 15, wherein the data transmission relationship is further associated with an outage-probability when at least a portion of the data is transmitted over the at least one auxiliary channel.

18. A communication system in accordance with claim 17, wherein the outage-probability is associated with the transmission resource allocation of the at least one auxiliary channel.

19. A communication system in accordance with claim 12, wherein the main channel is a licensed channel and the at least one auxiliary channel is an unlicensed channel.

20. A communication system in accordance with claim 12, further comprises a base station arranged to communicate over the main channel and the at least one access point arranged to communicate over the at least one auxiliary channel.
